(19) United States
(12) Patent Application Publication
(10) Pub. No.: US 2026/0118596 A1
(43) Pub. Date: Apr. 30, 2026

(54) OPTICAL FIBER PLUG CONNECTOR WITH A CLEANING FUNCTION

(71) Applicant: Robert Bosch GmbH, Stuttgart (DE)

(72) Inventors: Benjamin Traenkle, Stuttgart (DE); Markus Kroeckel, Bad Kissingen / Poppenroth (DE); Matthias Mahlich, Heilbronn (DE)

(21) Appl. No.: 19/352,720

(22) Filed: Oct. 8, 2025

(30) Foreign Application Priority Data
Oct. 25, 2024 (DE) 10 2024 210 337.3

(51) Int. Cl. G02B 6/38

(52) U.S. Cl. CPC G02B 6/3866; G02B 6/3869

(57) ABSTRACT

An optical fiber plug connector configured to connect a first optical conductor to a second optical conductor. The fiber plug connector including: a cleaning device, which is disposed such that it can rotate about a rotational axis, wherein the cleaning device comprises a cleaning element, wherein the cleaning element is designed to rotate about the rotational axis with the cleaning device when a plug connection is being established between the first optical conductor and the second optical conductor, so that the cleaning element comes into contact with a first cable end of the first optical conductor and a second cable end of the second optical conductor in order to clean the first and the second cable end.

### CROSS REFERENCE

The present application claims the benefit under 35 U.S.C. § 119 of Germany Patent Application No. DE 102024 210 337.3 filed on October 25, 2024, which is expressly incorporated herein by reference in its entirety.

### BACKGROUND INFORMATION

The present invention relates to an optical fiber plug connector with a cleaning function, which is designed to enable cleaning of the optical cable ends of the two optical conductors to be connected during a plugging process. The present invention also relates to an optical plug-in arrangement comprising such an optical fiber plug connector.

### BACKGROUND INFORMATION

Optical fiber plug connectors, such as light guide connectors can be soiled by environmental influences. This can disrupt data transmission or, in the worst case, prevent it completely. Cleaning could be done manually, but does not take place in most plugging processes. European Patent Application No. EP 3806927 B1 moreover describes a self-cleaning plug connector that provides self-cleaning with a liquid.

### SUMMARY

An optical fiber plug connector according to the present invention may have an advantage that automatic cleaning of the two conductor ends of the optical conductors is possible during a plugging process of optical conductors. This makes it possible to clean not only a plugged-in conductor, but also the receiving optical conductor. This enables an error-free optical connection between the first and the second optical conductor. Soiling can be removed at both conductor ends. This is achieved according to the present invention in that the optical fiber plug connector that is designed to connect a first optical conductor to a second optical conductor comprises a cleaning device, which is disposed such that it can rotate about a rotational axis. According to an example embodiment of the present invention, the cleaning device comprises a cleaning element which, when a plug connection is being established between the first and the second optical conductor, carries out a cleaning operation at a first cable end of the first optical conductor and a second cable end of the second optical conductor as a result of a rotation of the cleaning device. The cleaning element thus comes into contact with both cable ends of the optical conductor when it rotates in order to clean said two cable ends. The rotation is carried out as a result of the plugging process. This therefore automatically enables cleaning of both optical contact surfaces of the optical conductors during a plugging process to connect the two optical conductors.

The cleaning element is preferably a textile cleaning element or a nonwoven fabric or a flexible sponge or a brush or the like.

Preferred further developments of the present invention are disclosed herein.

According to an example embodiment of the present invention, the cleaning device preferably also comprises a holding element for holding the cleaning element. The rotational axis is disposed on the holding element. This makes it possible to prevent the cleaning element from being damaged by the frequent rotations about the rotational axis, in particular in the case of frequent plugging processes.

The holding element particularly preferably comprises a contact region, which is designed to come into contact with the plugged-in first optical conductor when the plug connection is being established between the first and the second optical conductor. This makes it possible to prevent damage to the optical conductor, in particular at the start of the plug-in process, because minor angular deviations between a desired insertion direction and an actually inserted direction of the optical conductor often occur at the start of the plug-in process and can lead to damage to the cleaning element.

The first and/or the second optical conductor preferably comprise a ferrule at the cable end to protect the optical fiber. The ferrule also has the advantage that the ferrule comes into contact with the holding element of the cleaning element during the plugging process, which, in particular at the start of the plugging process, prevents damage to the cleaning element.

The contact region of the holding element is preferably substantially U-shaped in cross-section. This also makes it possible to guide the inserted first optical conductor, in particular at the start of the plugging process.

According to another preferred configuration of the present invention, the cleaning element is substantially L-shaped in cross-section with a first leg and a second leg. The first leg is preferably designed to fix the cleaning element to the holding element and the second leg is designed to clean the cable ends of the optical fibers of the first and the second optical conductor.

The first optical conductor, which is moved for the plugging process, also preferably comprises a seal. The seal is preferably ring-shaped and is designed to create a seal at an opening in a housing part or the like.

The present invention also relates to an optical plug-in arrangement comprising an optical fiber plug connector of the present invention as described above.

According to an example embodiment of the present invention, the optical plug-in arrangement also preferably comprises a housing part with a through-opening, wherein the cleaning device is disposed on an inner side of the housing part adjacent to the through-opening. The optical plug-in arrangement is further preferably configured such that, in an unplugged state, the contact region of the holding element completely covers the through-opening in the housing part. This enables the cleaning device to protect the interior of the housing part in the unplugged state.

On the housing part at the through-opening, the optical plug-in arrangement moreover preferably comprises a guide region which faces toward the inner side of the housing part. The guide region on the housing part is designed to guide the first optical conductor during the plugging process. This improves the accuracy of the plugging process and in particular prevents damage to the cleaning device.

The present invention furthermore relates to a technical device, in particular a control unit comprising an optical plug-in arrangement according to the present invention as described above.

### BRIEF DESCRIPTION OF THE DRAWINGS

A preferred design example of the present invention is described in detail in the following with reference to the figures.

FIG. 1 shows a schematic sectional view of an optical plug-in arrangement comprising an optical fiber plug connector according to a preferred embodiment example of the present invention, in the unplugged state,

FIG. 2 shows a schematic, partially sectional detail view of the plug-in arrangement of FIG. 1 at the start of the plugging process.

FIG. 3 shows a schematic partial view of the plug-in arrangement of FIG. 1 at initial contact during the plugging process.

FIGS. 4 to 6 schematic illustrations showing the plugging process of the plug-in arrangement of FIG. 1.

FIG. 7 shows a perspective, schematic partial sectional view of a holding element of a cleaning device of the plug-in arrangement, according to an example embodiment of the present invention.

FIG. 8 shows a schematic, perspective partial sectional view of a housing of the plug-in arrangement of FIG. 1, according to an example embodiment of the present invention.

### DETAILED DESCRIPTION OF EXAMPLE EMBODIMENTS

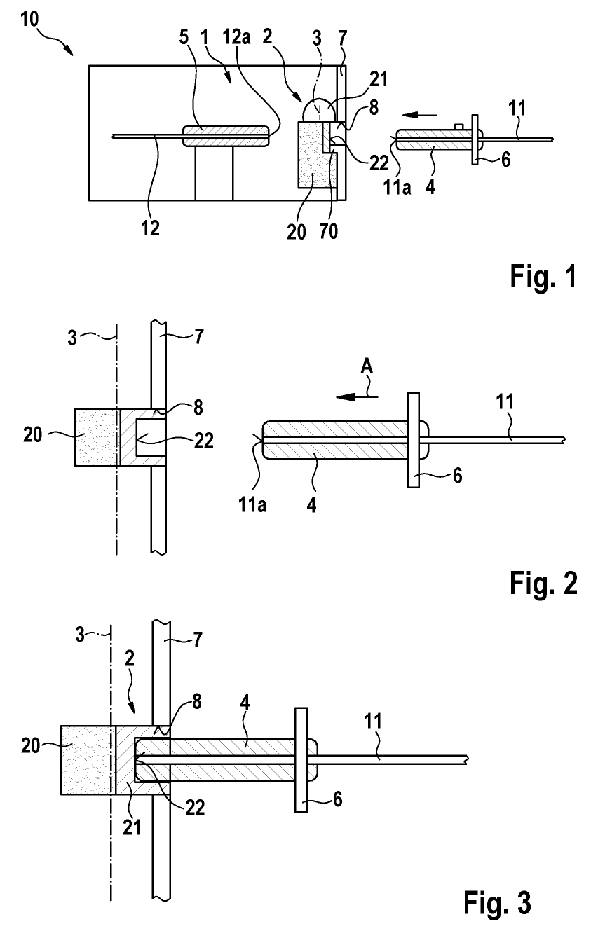

In the following, an optical plug-in arrangement 10 with an optical fiber plug connector 1 is described in detail with reference to FIGS. 1 to 8.

As can be seen from FIG. 1, the optical fiber plug connector 1 is designed to connect a first optical conductor 11 to a second optical conductor 12, for example in order to enable the transmission of data or the like by optical means.

The optical fiber plug connector 1 comprises a cleaning device 2, which can be seen in detail in FIGS. 1 to 6. The cleaning device 2 is disposed such that it can rotate about a rotational axis 3.

The cleaning device 2 is disposed on an inner side of a housing part 7. The rotational axis 3 is disposed inside the housing part 7.

As can be seen in particular from FIG. 1, the cleaning device 2 is partially disposed in front of a through-opening 8 in the housing part 7.

The cleaning device 2 comprises a cleaning element 20, which is designed to clean a first cable end 11a of a first optical conductor 11 and a second cable end 12a of a second optical conductor 12 during the plugging process.

The cleaning device 2 further comprises a holding element 21, which is designed to hold the cleaning element 20. The rotational axis 3 is configured on the holding element 21.

The cleaning element 20 can be exchangeably disposed on the holding element 21.

A first ferrule 4 is disposed on the free end of the first optical conductor 11. A second ferrule 5 is disposed on the free end of the second optical conductor 12. The ferrules serve to protect and guide the optical fiber lines of the optical conductors.

As can be seen in particular from FIGS. 2 to 4, the holding element 21 comprises a contact region 22. The contact region 22 is designed to contact the first optical conductor 11 when the latter is inserted through the through-opening 8 in the housing part 7 in the insertion direction as indicated in FIGS. 1 and 2 with the arrow A. The holding element 21 comprises a region that is substantially U-shaped in cross-section, on which the contact region 22 is configured on the bottom region that connects the two legs of the U-shaped region.

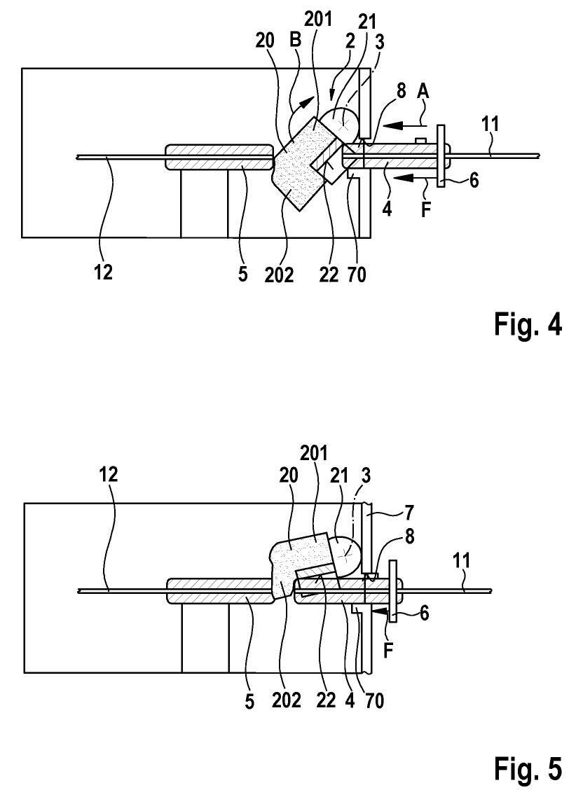

As can be seen from FIGS. 3 and 4, it is not the very delicate cable end 11a of the first optical conductor 11 that comes into contact with the contact region 22, but rather the first ferrule 4. This protects the delicate cable end 11a from damage during the plugging process.

The progression of the plugging process is evident in particular from FIGS. 1 to 6, and FIG. 6 shows the final plugged state of the optical plug-in arrangement 10.

In FIGS. 1 to 6, the insertion direction is indicated with the arrows A. As soon as the first ferrule 4 comes into contact with the contact region 22 of the holding element 21, as shown in FIG. 3, the cleaning device 2 starts to pivot about the rotational axis 3 which is schematically indicated in FIG. 4 with the arrow B. At the start of the plugging process, the first ferrule 4 or the end of the first optical conductor 11 does not come into contact with the cleaning element 20, which can be a nonwoven fabric or a textile or a brush or the like.

During the plugging process, as the cleaning device 2 starts to rotate, only the ferrule 4 comes into contact with the contact region 22 (see FIGS. 4 and 5).

Only once a predetermined pivot angle has been overcome by the pivoting action of the cleaning device 2 does the first cable end 11a come into contact with the cleaning element 20 and is cleaned (FIG. 5).

The cleaning element 2 has an L-shape with a first leg 201 that serves to fix the cleaning element 20 to the holding element 21 and a second leg 202 that serves to clean the two cable ends 11a, 12a in contact. This can also cause deformation of the cleaning element 20, as indicated in the figures.

The angle after which the cleaning element 20 is in contact with the first cable end 11a of the first optical conductor 11 is approximately 70°. An angle at which the cleaning element 20 comes into contact with the second cable end 12a of the second optical conductor 12 is smaller, as shown in FIG. 4, and is approximately 45°. At this point, the cleaning element 20 is not yet in contact with the first cable end 11a of the first optical conductor 11. Only once the plug-in position of the first optical conductor 11 shown in FIG. 5 is reached does the cleaning element 20 also come into contact with the first cable end 11a of the first optical conductor 11. The two cable ends 11a, 12a are then both cleaned at the same time.

The cleaning element 20 thus uses the pivoting movement of the cleaning element 20 to clean both the first cable end 11a and the second cable end 12a. This results in a period of time in which both cable ends 11a, 12a are being cleaned at the same time.

The U-shaped configuration on the contact region 22 of the holding element 21 allows the ferrule bump against and slide past it during the plugging process. The cleaning element 20 can preferably have the same height as the contact region 22, or more preferably even a greater height. This arrangement protects the cleaning element from external influences when unplugged, but allows the ferrule and internal fiber to brush over it during the plugging process for cleaning.

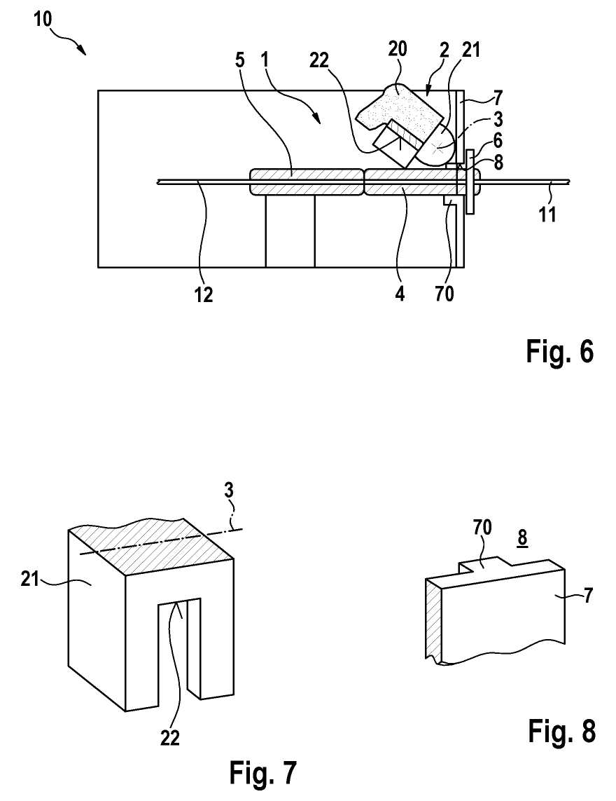

As can be seen in detail from FIGS. 6 and 8, the housing part 7 has another configuration 70 at the through-opening 8 in the form of a guide region that faces toward the inner side of the housing part 7. In the closed state, this configuration 70 seals the holding element 21 (FIG. 1). This configuration 70 moreover serves to guide the first optical conductor 11 inserted into the through-opening 8, wherein the guidance takes place on the outer perimeter of the first ferrule 4. This can be seen in detail in FIGS. 3 and 4.

A seal 6 is also provided on the first optical conductor 11. The seal 6 is disposed at an end of the first ferrule 4 facing away from the first cable end 11a. The seal 6 can be made of an elastic material and is ring-shaped. As shown in the plugged-in end state of FIG. 6, the seal 6 then rests against an outer side of the housing part 7 and seals the optical plug connection against external influences.

When the optical plug-in arrangement 10 is in the unplugged state, which is shown in FIG. 1, the cleaning device 2 is disposed in front of the through-opening 8 such that said opening is closed by the cleaning device 2. This prevents dirt or the like from entering the inner region of the housing part 7. The through-opening 8 is therefore covered only by the region of the holding element 21. The holding element 21 thus also comes into contact with an end face of the guide region 70 in order to achieve a secure seal.

The delicate cleaning element 20 is not used to seal the through-opening 8, so that dirt or the like cannot accumulate in the cleaning element 20. Preventing the accumulation of dust or other particles on the cleaning element 20 is of utmost importance, because said particles could scratch and damage the cable ends 11a, 12a of the optical conductors during the cleaning process.

The optical fiber plug connector 1 can thus clean the cable ends 11a, 12a until physical contact is established between the two cable ends 11a, 12a (see FIG. 6). A plugging force F is used to rotate the cleaning device 2 about the rotational axis 3. The delicate optical fibers of the optical conductors are then cleaned as it rotates. Automatic cleaning during the plugging process therefore ensures that the delicate cable ends 11a, 12a are always cleaned so that, after every plugging process, there is always dirt-free contact between the two cable ends 11a, 12a for optimum transmission capability at the plug-in arrangement 10.

The cleaning device 2 provides protection against the ingress of particles from outside into the interior of the housing part 7 even when the optical conductors are unplugged.

What is claimed is:

1. An optical fiber plug connector which is configured to connect a first optical conductor to a second optical conductor, the fiber plug connector comprising:
a cleaning device which is disposed such that the cleaning device can rotate about a rotational axis;
wherein the cleaning device includes a cleaning element, wherein the cleaning element is configured to rotate about the rotational axis with the cleaning device when a plug connection is being established between the first optical conductor and the second optical conductor, so that the cleaning element comes into contact with a first cable end of the first optical conductor and a second cable end of the second optical conductor to clean the first cable end and the second cable end.

2. The fiber plug connector according to claim 1, wherein the cleaning device further includes a holding element which holds the cleaning element, wherein the rotational axis is disposed on the holding element.

3. The fiber plug connector according to claim 2, wherein the holding element includes a contact region, which is configured to come into contact with the first optical conductor when the plug connection is being established between the first optical conductor and the second optical conductor to rotate the cleaning device.

4. The fiber plug connector according to claim 1, wherein the first optical conductor and/or a second optical conductor includes a ferrule on the first cable end and/or the second cable end, respectively.

5. The fiber plug connector according to claim 3, wherein the contact region is substantially U-shaped in cross-section to provide unobstructed guidance of the first optical conductor during the plugging process.

6. The fiber plug connector according to claim 1, wherein the cleaning element is substantially L-shaped in cross-section with a first leg and a second leg.

7. The fiber plug connector according to claim 1, wherein a seal is disposed on the first optical conductor to provide a seal at a through-opening after a plugging process has been completed.

8. An optical plug-in arrangement, comprising:
an optical fiber plug connector which is configured to connect a first optical conductor to a second optical conductor, the fiber plug connector including:
a cleaning device which is disposed such that the cleaning device can rotate about a rotational axis;
wherein the cleaning device includes a cleaning element, wherein the cleaning element is configured to rotate about the rotational axis with the cleaning device when a plug connection is being established between the first optical conductor and the second optical conductor, so that the cleaning element comes into contact with a first cable end of the first optical conductor and a second cable end of the second optical conductor to clean the first cable end and the second cable end.

9. The optical plug-in arrangement according to claim 8, further comprising:
a housing part with a through-opening, wherein the cleaning device is disposed on an inner side of the housing part adjacent to the through-opening.

10. The optical plug-in arrangement according to claim 9, wherein:
the cleaning device further includes a holding element which holds the cleaning element,
the rotational axis is disposed on the holding element,
the holding element includes a contact region, which is configured to come into contact with the first optical conductor when the plug connection is being established between the first optical conductor and the second optical conductor to rotate the cleaning device, and
in an unplugged state, the contact region of the holding element completely covers the through-opening (8) to protect against the ingress of particles.

11. The optical plug-in arrangement according to claim 8, wherein, at the through-opening, the housing part includes a guide region which faces toward an inner side of the housing part.
